(19) United States
(12) Patent Application Publication
(10) Pub. No.: US 2015/0106222 A1
(43) Pub. Date: Apr. 16, 2015

(54) SYSTEM AND METHOD OF SUPPLYING CUSTOMERS A PRODUCT

(71) Applicant: W. Edwards, Inc., Lincolnton, NC (US)

(72) Inventor: David Edwards, Lincolnton, NC (US)

(21) Appl. No.: 14/513,599

(22) Filed: Oct. 14, 2014

Related U.S. Application Data
(60) Provisional application No. 61/890,584, filed on Oct. 14, 2013.

(51) Int. Cl. G06Q 30/08

(52) U.S. Cl. CPC G06Q 30/08
USPC 705/26.3

(57) ABSTRACT

A system and method of supplying customers a product is disclosed. The method includes the steps of creating a request list containing items that the consumer would like to purchase, transmitting the request list to the plurality of suppliers for a quote, receiving the quotes from the plurality of suppliers and selecting suppliers from the plurality of suppliers to contact, and agreeing to terms of sale and closing the request list.

### BACKGROUND OF THE INVENTION

The present invention relates generally to a system and method of supplying customers a product. More particularly, it relates to a method of permitting landscapers and suppliers to interact with each other in order to permit the landscapers to obtain supplies from a supplier.

While the following description is directed to a landscaper/supplier relationship, it should be appreciated that the method of the current invention is not limited to the landscaping business and may be used in other customer/supplier relationships and that the landscape/supplier relationship is being used as one example for discussion purposes.

One of the problems facing landscapers today is the inability to know which growers or landscape suppliers have the plants, mulch, etc., needed to complete a job. As a result, landscapers spend an inordinate amount of time calling or visiting such suppliers to purchase supplies. Since most growers or landscape suppliers do not always have all of the landscapers' needs in stock, the landscaper is often required to visit multiple growers or landscape suppliers.

Accordingly, there is a need for an easier way for landscapers to obtain product for each landscape job.

### SUMMARY OF THE INVENTION

These and other shortcomings of the prior art are addressed by the present invention, which provides a system and method configured to allow a landscaper to find and purchase product without spending an inordinate amount of time calling or visiting suppliers.

According to one aspect of the invention, a system configured to permit a consumer to request bids from multiple suppliers includes a processor having software thereon, the processor being accessible to both consumers and suppliers through a communications network and configured to provide a hub to allow interaction between the consumers and suppliers. The hub is configured to provide a request module, a transmission module, a bid module, and a close-out module. The request module is executed by the processor in response to a consumer logging into the system. The request module is configured to permit the consumer to create a request list for submission to a supplier. The transmission module is executed by the processor in response to the submission of the request list or a bid from the suppliers. The transmission module is configured to automatically transmit the request list to suppliers for bidding or to transmit the bids from the suppliers to the consumer. The bid module is executed by the processor in response to the request list being transmitted to the suppliers. The bid module is configured to permit the suppliers to bid on items contained in the request list. The close-out module is executed by the processor in response to the bids being received by the consumer. The close-out module is configured to permit the consumer and suppliers to correspond with each other to finalize terms of sale and close-out the request list. The system permits a consumer to request bids from multiple suppliers at one time.

According to another aspect of the invention, a method for conducting a sale transaction between a consumer and a plurality of suppliers includes the steps of creating a request list containing items that the consumer would like to purchase, transmitting the request list to the plurality of suppliers for a quote, receiving the quotes from the plurality of suppliers and selecting suppliers from the plurality of suppliers to contact, and agreeing to terms of sale and closing the request list.

According to another aspect of the invention, a method for conducting a sale transaction includes the steps of providing a centralized hub configured to connect consumers to suppliers. The hub is configured for access through a communications network. The method further including the steps of having a consumer log into the hub as a consumer and create a request, using the hub to automatically transmit the request to a plurality of suppliers for quotes on each item included on the request, having the plurality of suppliers log into the hub as a supplier to submit quotes for each item on the request, and using the hub to automatically transmit the quotes from the plurality of suppliers to the consumer.

### BRIEF DESCRIPTION OF THE DRAWINGS

The subject matter that is regarded as the invention may be best understood by reference to the following description taken in conjunction with the accompanying drawing figures in which:

FIG. 1 is a graphical representation of the system and method according to an embodiment of the invention;

FIG. 2 is a flow chart showing landscapers and suppliers connected by a hub for the system of FIG. 1;

FIGS. 3, 4, and 10 are flow charts showing the steps that a landscaper takes to receive bids/quotes for the system of FIG. 1;

FIGS. 5-9 are flow charts showing the steps that a supplier takes in providing bids/quotes for the system of FIG. 1;

FIG. 11 illustrates a sign-up process for landscapers and suppliers for the system of FIG. 1;

FIG. 12 is a graphical representation of a system and method according to an embodiment of the invention; and

FIG. 13 is a flow chart showing a system and method according to an embodiment of the invention.

### DETAILED DESCRIPTION OF THE INVENTION

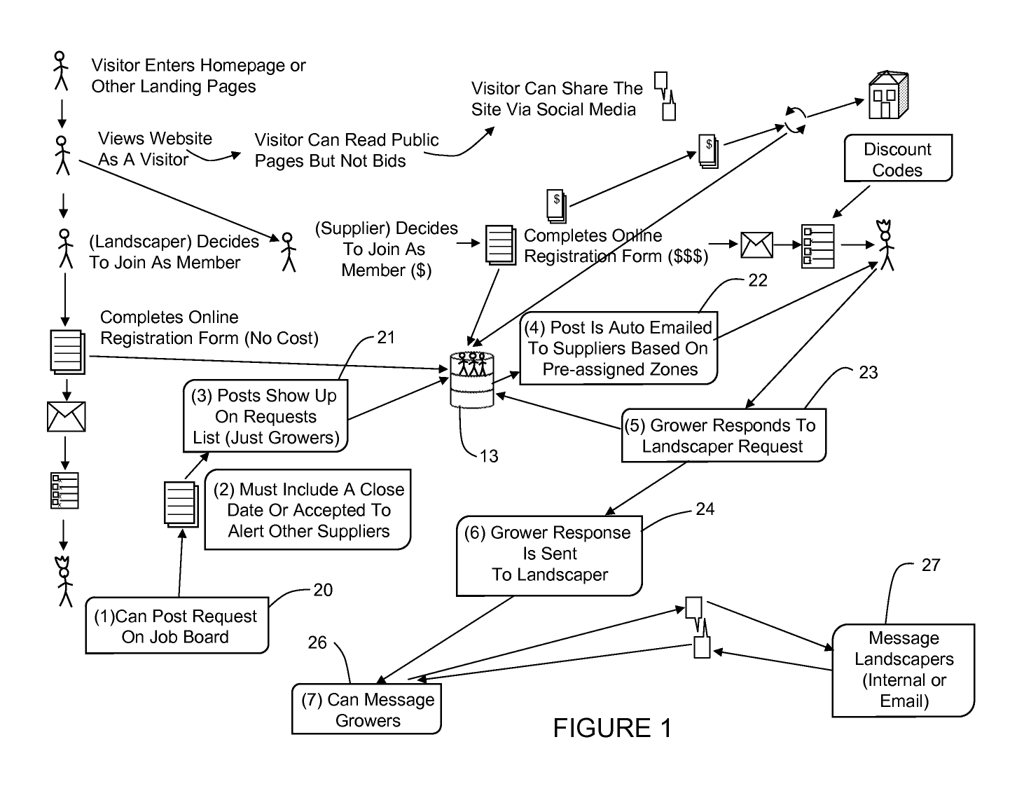

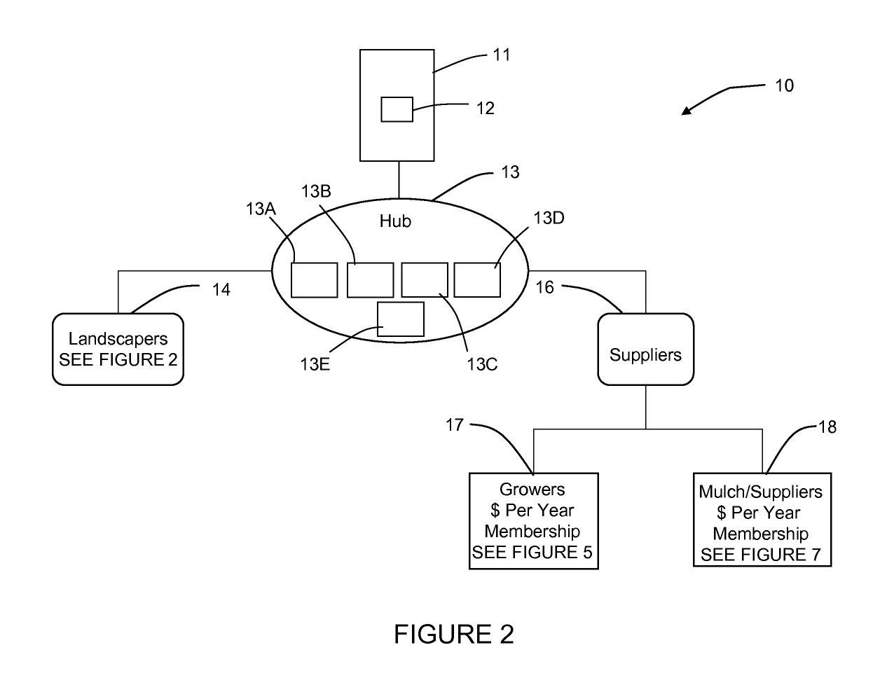

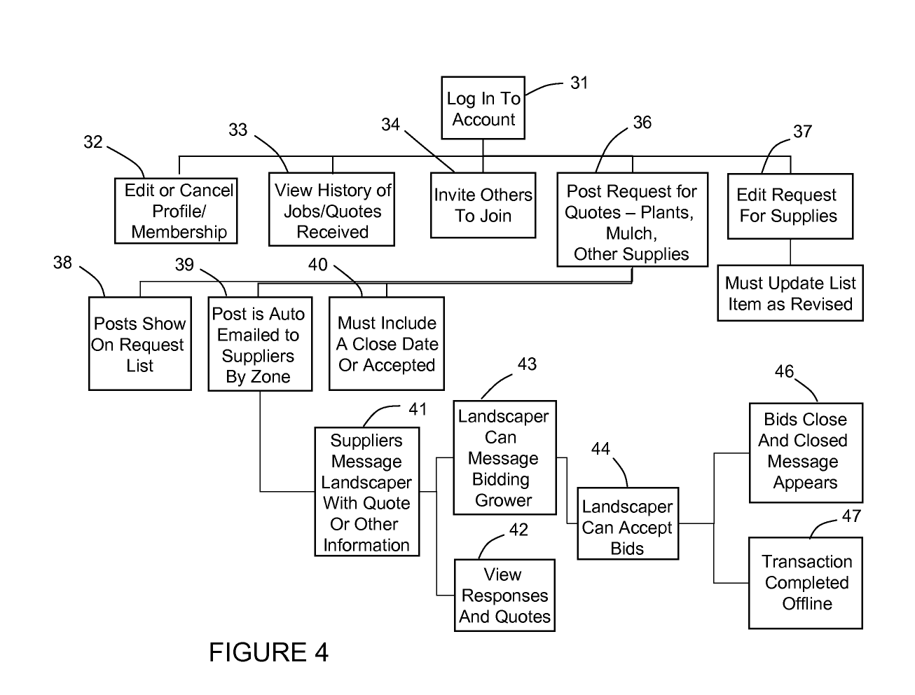

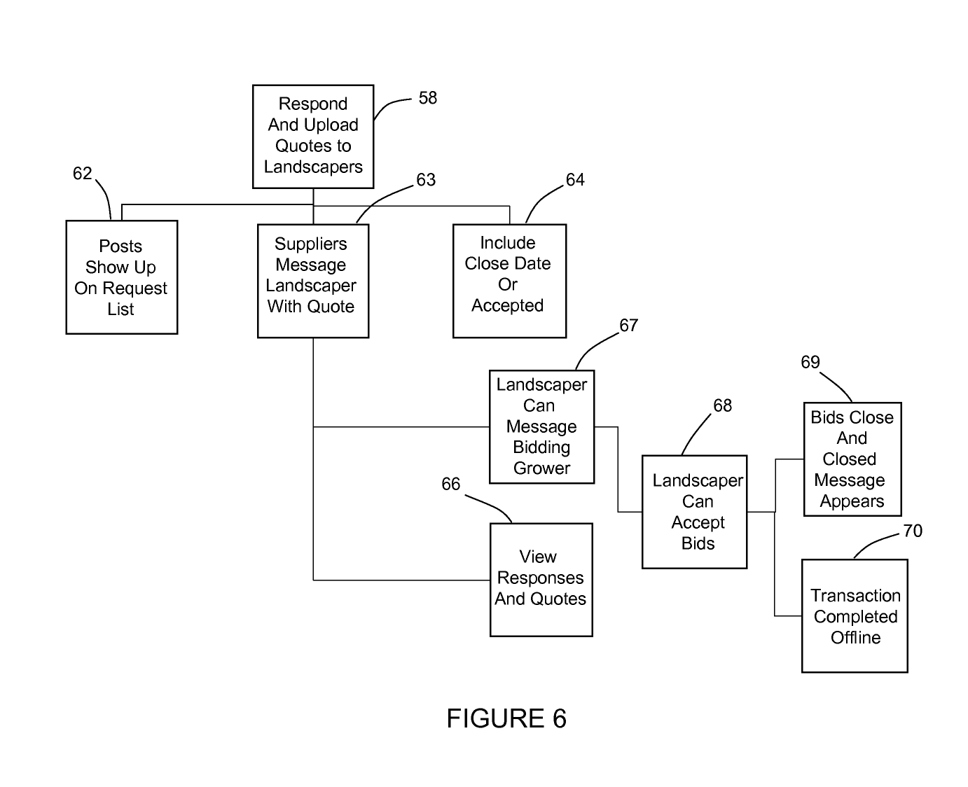

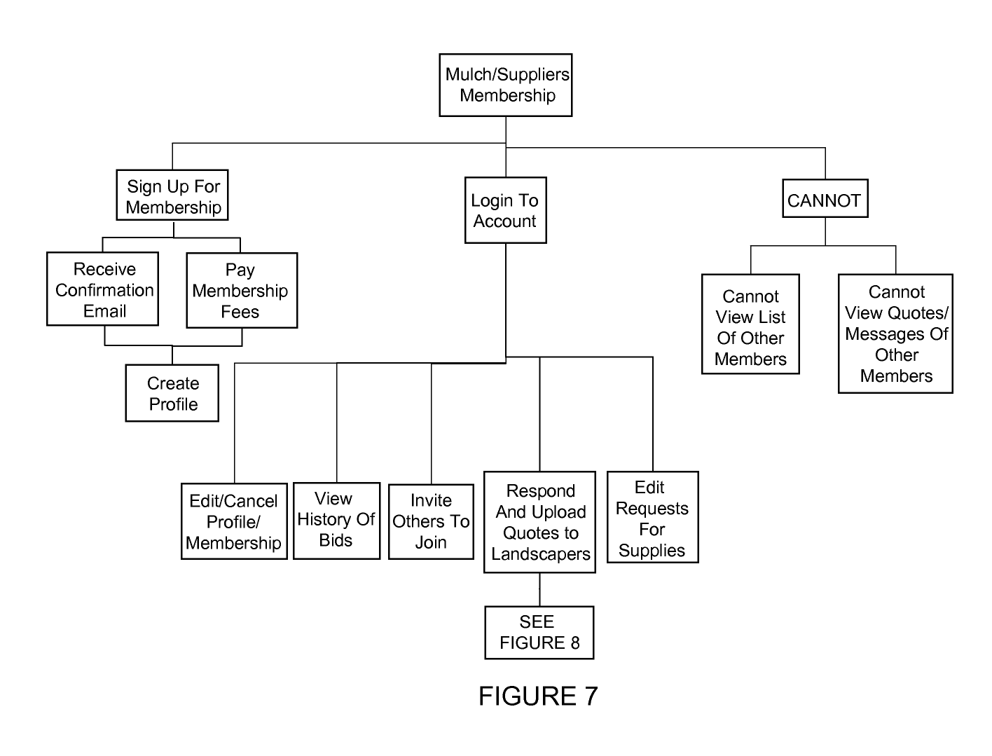

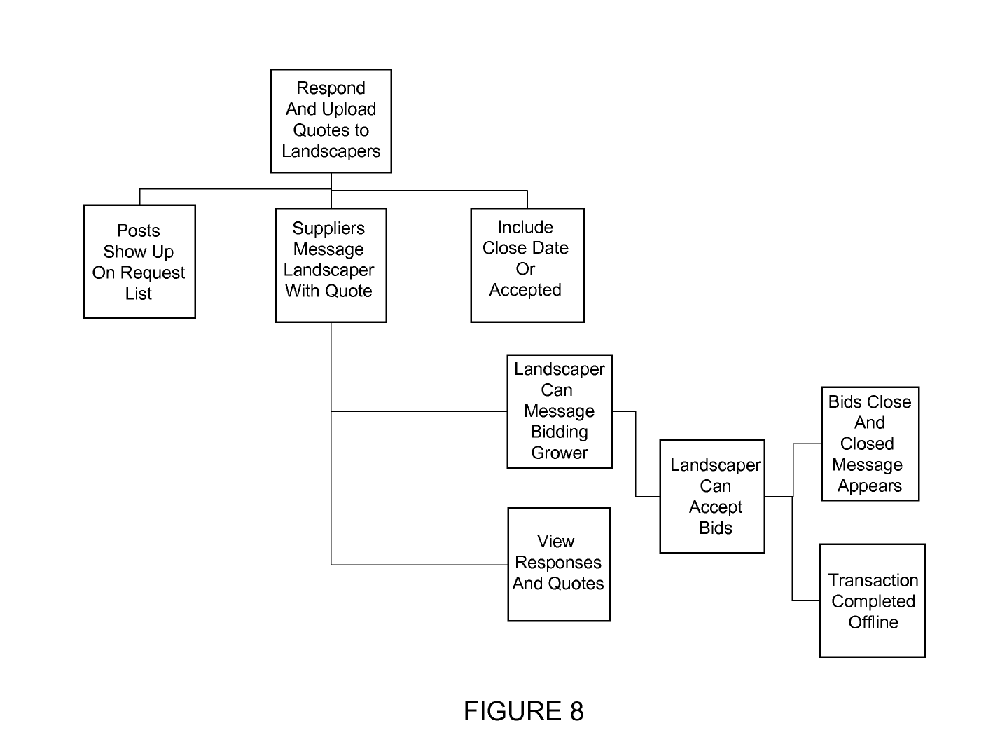

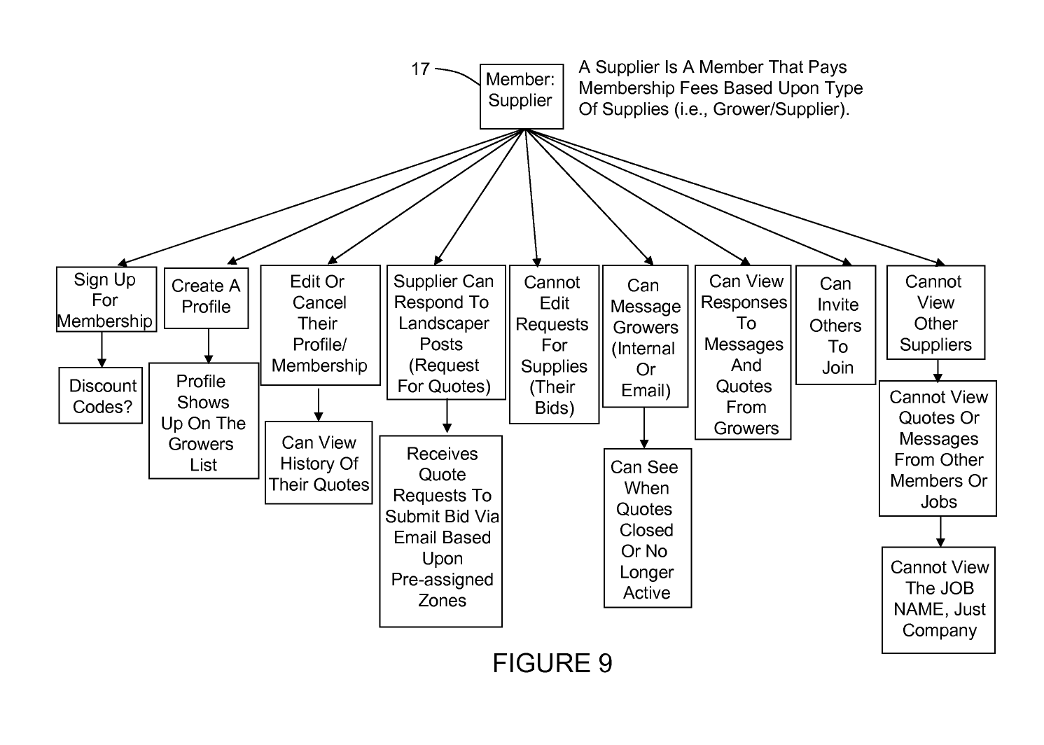

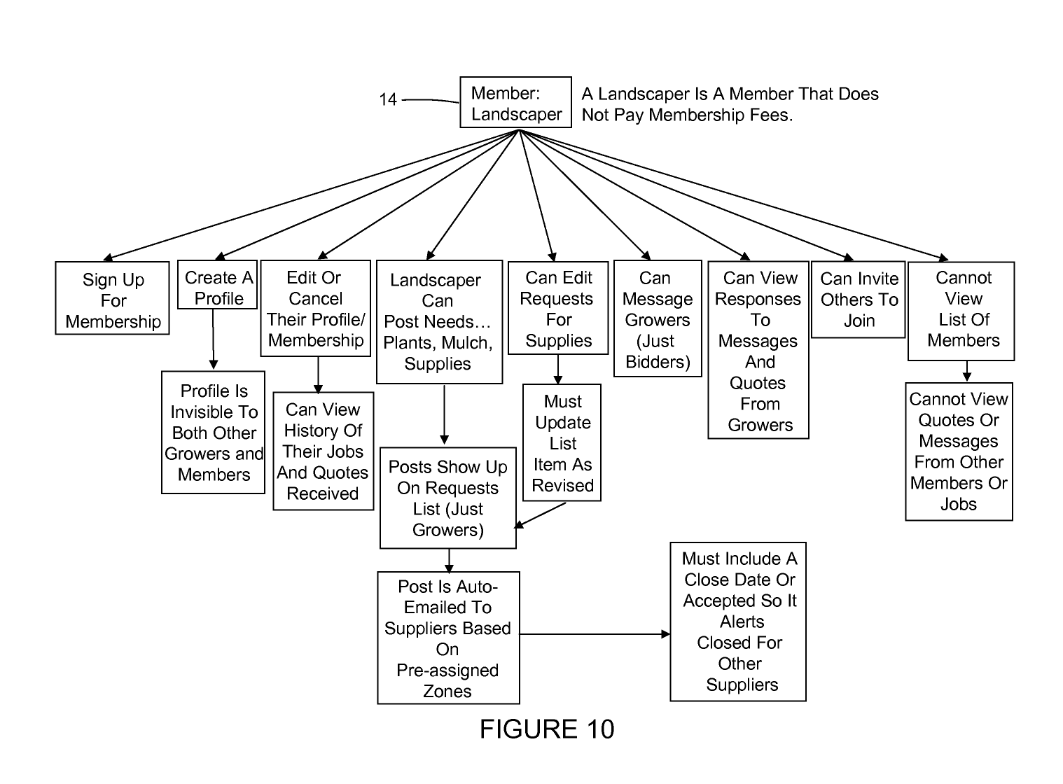

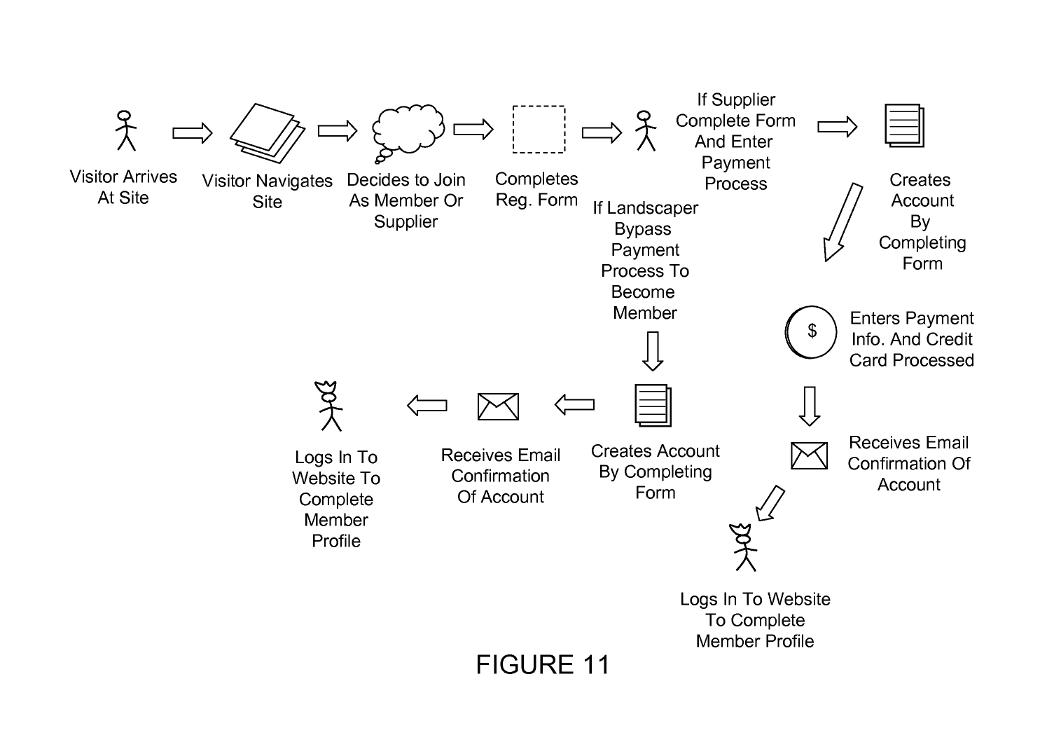

Referring to the drawings, an exemplary system and method according to the present invention is illustrated in FIGS. 1-11 and shown generally at reference numeral 10. The system 10 includes a server 11 having a processor 12 and software configured to permit a customer/supplier relationship for the purposes of obtaining and supplying a product easily. The system 10 is configured to provide a web portal or other communications networks for accessing the system 10 by both the customer and the supplier and performs processing functions to enable transactions between them. For example, a typical web portal or communications network might be a centralized server having software contained thereon to provide a user interface. The server is accessed by users connected to the internet via home terminals.

For purposes of clarity, the invention will be further discussed as a landscaper/supplier relationship to provide a single example. It should be appreciated that the invention is not limited to a landscaper/supplier relationship; rather, the invention is configured to provide a customer/supplier relationship in its most general form.

As shown in FIGS. 1-11, the software contained on the server/processor provides a centralized hub 13 that connects landscapers 14 with suppliers 16. In the current example, the suppliers are broken down into growers 17 and mulch/suppliers 18. It should be appreciated that there may be a single supplier or multiple suppliers. The hub 13 provides control modules for controlling transactions taking place between the landscapers and suppliers and sets rules for those transactions. It should be understood, that the hub is the heart of the system. For example, the hub 13 includes a membership module 13A configured to permit landscapers 14 and suppliers 16 to create a membership and log in to the system 10—this module also controls all actions regarding the user's profile; a request module 13B configured to allow a landscaper to create a request list for submission to suppliers 16; a transmission module 13C configured to transmit the request list to the suppliers 16 for bidding, as well as, to transmit bids from the suppliers 16 to the landscaper 14; a bid module 13D configured to permit suppliers 16 to bid on items contained in the request list for submission to the landscaper 14; and a close-out module 13E configured to permit the landscaper 14 and suppliers 16 to negotiate terms of sale and to close-out the request list.

Referring to FIG. 1, generally, the landscaper 14 posts a request on a job board provided by the system 10, block 20. The request is placed on a request list, block 21, and the request list is auto-emailed to suppliers 16 based in a corresponding pre-assigned zone, block 22. The supplier 16 responds to the landscaper's request, block 23, and the response is sent to the landscaper 14, block 24. The landscaper 14 and suppliers 16 can then message back and forth to negotiate the number of product being supplied as well as the unit price for each product, blocks 26 and 27.

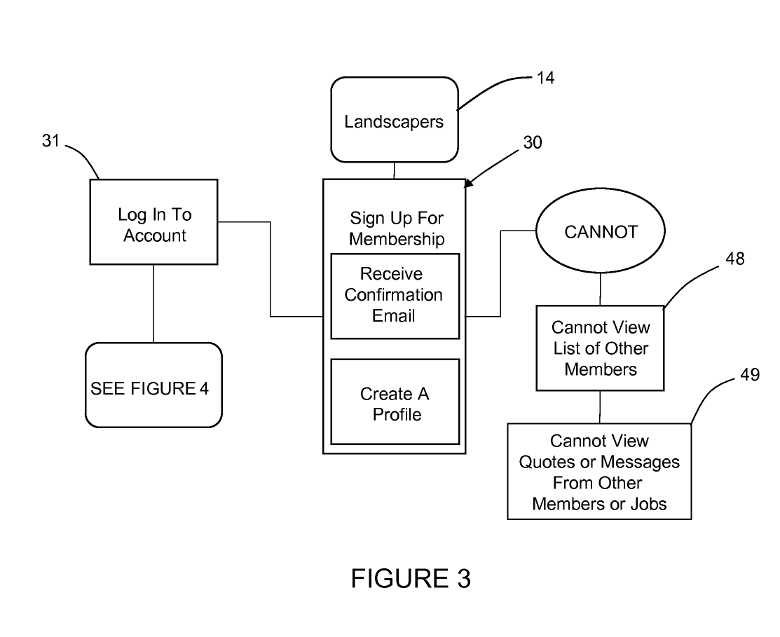

As shown in FIGS. 3, 4 and 10, the landscaper 14 accesses the system 10 by signing up for a membership, block 30, and creating a profile. Once the landscaper 14 creates his/her membership, the landscaper 14 can log in to the system 10, block 31. Once logged in, the landscaper 14 can conduct various activities, for example, the landscaper 14 can edit or cancel his membership, block 32; view history of jobs/quotes received, block 33; invite others to join, block 34; post requests for quotes, block 36; and edit requests, block 37. When posting a request for quotes, block 36, the request shows up on a request list, block 38, is auto-emailed to suppliers based on zone, block 39, and must include a close date or accepted date to alert other suppliers that the request has been filled, block 40. It should be understood that the request is open to all suppliers assigned to the zone. It should also be understood that the zone refers to a specified region on a map, for example, a zone may be a tri-state region or in the case of plants, it may be designated by growing regions such as zone 7.

Once the request list is received by the suppliers 16, the suppliers can message the landscaper 14 with a quote or other information, block 41. The landscaper 14 can then view responses and quotes, block 42, and message the suppliers 16 that the landscaper 14 wishes to contact, block 43. The landscaper 14 can then negotiate with the suppliers 16 and accept their bids, block 44. The bids are then closed, block 46, and the transaction completed offline, block 47.

As illustrated in FIG. 3, the landscaper 14 cannot view request lists or quotes and messages from other members and jobs, blocks 48 and 49.

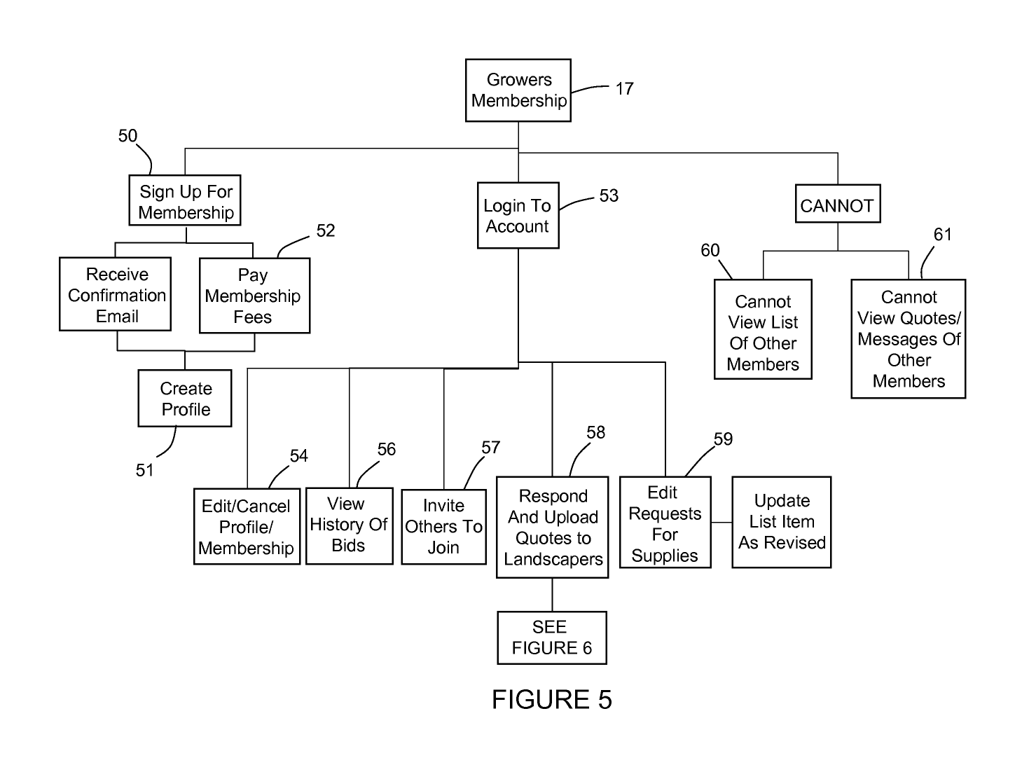

To avoid repetition, the supplier 16 description will only be discussed with respect to a grower 17. It should be appreciated that the basic steps shown for a grower 17 in FIGS. 5, 6, and 9 also apply generally to other types of suppliers, such as mulch/supplier 18.

Referring now to FIGS. 5, 6, and 9, the grower 17 sets up a membership, block 50, and creates a profile, block 51. Unlike a landscaper 14, the grower 17 also pays a membership fee, block 52. Once the membership is valid, the grower 17 logs in to the system 10 for access, block 53. Once logged in, the grower 17 can edit/cancel membership, block 54; view history of bids, block 56; invite others to join, block 57; respond and upload quotes to landscapers, block 58; and edit requests for supplies, block 59. The grower 17 cannot view lists of other members or quotes and messages, blocks 60 and 61.

If the grower 17 responds and uploads a quote, block 58, the quote shows up on the request list, block 62, and the grower 17 can message with the landscaper 14, block 63, with quote and close date, block 64. The landscaper 14 can then view the quotes and message the winning grower or growers 17, blocks 66 and 67, to accept the bids, block 68, and complete the transaction(s), blocks 69 and 70. It should be appreciated that more than one grower may submit bids to the landscaper and that more than one bid may be accepted by the landscaper. For example, the landscaper may fill part of the request from one supplier and another part of the request from a second supplier.

A more detailed explanation of the above discussion is as follows:

(1) A user visits a homepage for the system 10. The homepage may be available to the user as a website or any other means providing easy access. At the homepage, the user chooses if they are a landscaper 14 or supplier 16 (grower 17 or mulch/supplier 18).

(2) If landscaper 14 is chosen, the system 10 takes the user to a sign up page. Landscaper fills out an information sheet with a username and password, and submits the form electronically. Landscaper gets a confirmation email telling them they are a member via email.

(3) If grower 17 is chosen, grower 17 fills out an information sheet with a username and password and credit card information. Suppliers 16 pay a fee for access to the list of supply requests. Grower 17 submits the form electronically. Grower 17 gets a confirmation email telling them they are now member.

(4) If mulch/supplier 18 is chosen, mulch/supplier 18 fills out an information sheet with a username and password and credit card information. Suppliers 16 pay a fee for access to the list of supply request. Mulch/supplier 18 submits form electronically. Mulch/supplier 18 gets a confirmation email telling them they are now a member.

(5) After landscaper 14 is a member they can post their supply request. Posting a supply request works as follows:
(i) Landscaper 14 logs into their account and clicks on the (add a request) link.
(ii) System 10 brings them to a page to list the supplies the landscaper needs. The supplies may also be entered by using a pre-populated database.
(iii) There are two sections: first section is for landscaper to post “plant needs” (e.g. trees, plants, flowers). The landscaper posts “plant needs” and submits the request.
(iv) The second section is for posting “supply needs” (e.g. Seed, Fertilizer, Sod, Hardscaping and Irrigation Parts). The landscaper posts “supply needs” and submits the request.

(6) After a post has been submitted by a landscaper 14, the grower 17 or mulch/supplier 18 can log into their account and they can see the “supply need” post the landscaper posted on a list. The grower 17 or supplier 18 can then click on the post. The post opens and the grower 17 or supplier 18 can type their bid on portions of the “supply need” post and click submit. The grower 17 or supplier 18 then has submitted their bid to the landscaper 14.

(7) Landscaper 14 can then see the bid that the supplier 18 or grower 17 has posted. Landscaper then can accept any bid given by the grower 17 or supplier 18.

(8) The grower 17 or supplier 18 can then converse with the landscaper 14 via email or via website to set up shipping or pickup of material.

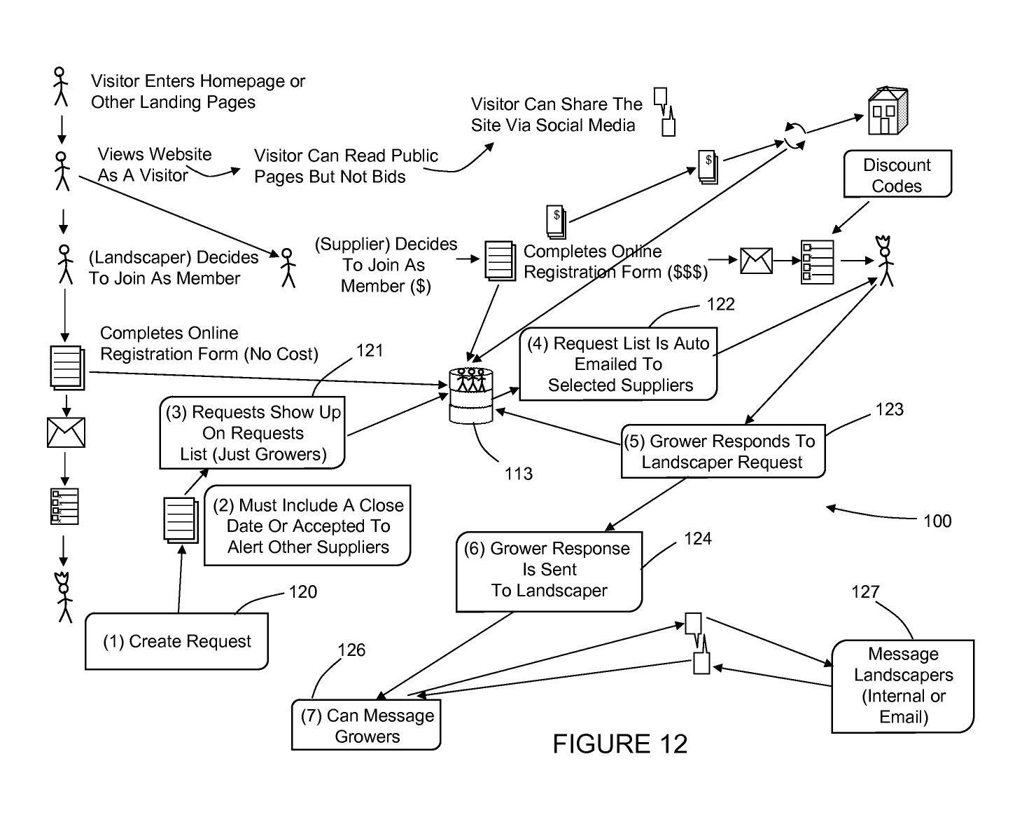

Referring now to FIG. 12, where like numbers represent like elements, a system and method according to an alternative embodiment is shown generally at reference numeral 100. The system and method 100 uses the same system, i.e., server, processor, and software, as system 10 except that the process for submitting a request no longer requires submission to a job board. In the current method, the landscaper 14 creates a request, block 120, that is loaded onto a request list, block 121. The request list is pushed to the hub 113 along with a list of selected suppliers. It should be understood, that in this embodiment of the invention, the landscaper 14 actually chooses which suppliers 16 to submit the request to, as opposed to the list being uploaded to a general job board for all suppliers to see. The hub 113 then emails the request list to the selected suppliers, block 122. Once the supplier 16 receives the request list, the supplier 16 responds to the landscapers request, blocks 123 and 124. The suppliers and landscapers can then message each other through the system 100 or via external communications means, such as email, texting, telephone, etc., blocks 126 and 127. It should be appreciated that unlike the system and method 10, system and method 100 allows the landscaper and supplier to view each others profile. This provides a measure of security to prevent false posts from being uploaded to the system.

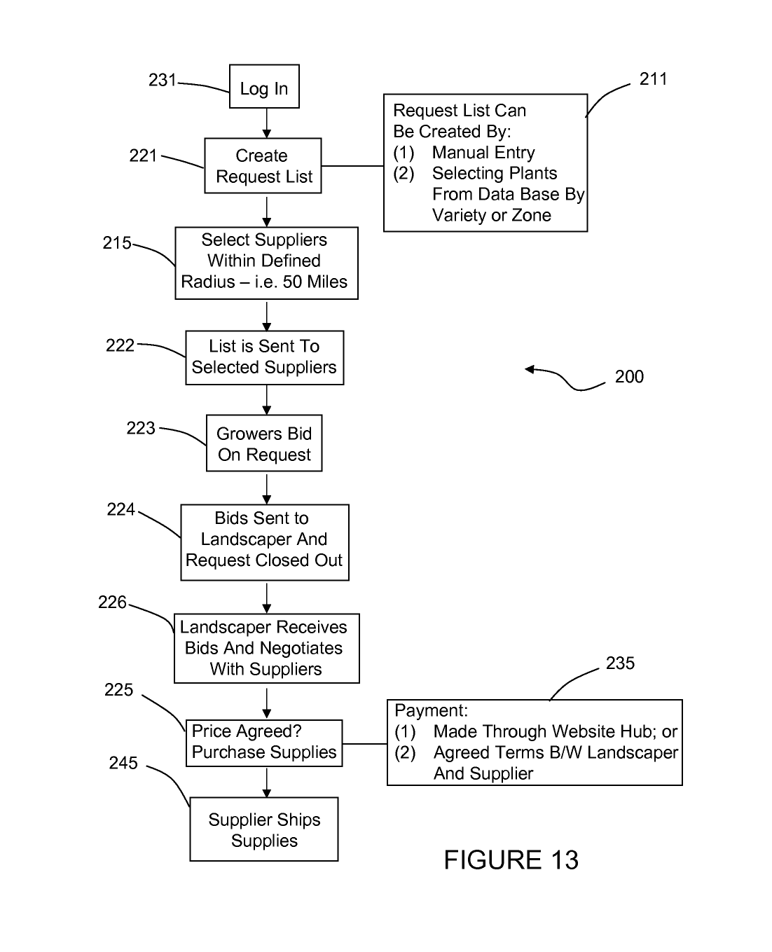

Referring now to FIG. 13, where like numbers represent like elements, a system and method according to an alternate embodiment of the invention is shown generally at reference numeral 200. The system and method 200 includes the same system, i.e., server, processor, and software, as system 10 except that the process or method of operation is different. As shown, a landscaper 14 logs in to the system 200, block 231, and creates a request list, block 221. The request list may be generated manually by typing in each requested supply or by using a pre-populated data base, block 211. If the data base is used, the landscaper may sort through the data base by variety/type of plant or by searching for plants designated by growing zone. Once the desired plant is found in the data base, the landscaper simply clicks on the plant and designates the number of plants needed—the information is then automatically populated into the request list.

Once the request list, block 221, is completed, the landscaper 14 selects suppliers 16 located within a pre-defined area, for example, a 50 mile radius, block 215. The request list is then auto emailed by the hub 213 to the selected suppliers, block 222. The suppliers 16 then bid on the request, block 223, and send the bids back to the landscaper, block 224. The request is closed out at this point. The landscaper 14 receives the bids from the suppliers 16 and begins to negotiate with the suppliers 16, block 226. It should be appreciated that communications between the landscaper and suppliers may be make internally through the system 200 or externally via email, text, etc. Once the price is agreed upon, the supplies are purchased, block 225. The purchase of the supplies may be made through the system 200 via the hub 213 or via agreed to terms between the landscaper 14 and supplier 16, block 235. The supplier then ships the supplies to the landscaper or provides them for pickup, block 245. It should be appreciated that unlike the system and method 10, system and method 200 allows the landscaper and supplier to view each others profile. This provides a measure of security to prevent false posts from being uploaded to the system.

The foregoing has described a system and method of supplying customers a product. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

I claim:

1. A system configured to permit a consumer to request bids from multiple suppliers, comprising:
(a) a processor having software thereon, the processor being accessible to both consumers and suppliers through a communications network and configured to provide a hub to allow interaction between the consumers and suppliers, the hub being configured to provide:
(i) a request module executed by the processor in response to a consumer logging into the system, the request module being configured to permit the consumer to create a request list for submission to a supplier;
(ii) a transmission module executed by the processor in response to the submission of the request list or a bid from the suppliers, the transmission module being configured to automatically transmit the request list to suppliers for bidding or to transmit the bids from the suppliers to the consumer;
(iii) a bid module executed by the processor in response to the request list being transmitted to the suppliers, the bid module being configured to permit the suppliers to bid on items contained in the request list; and
(iv) a close-out module executed by the processor in response to the bids being received by the consumer, the close-out module being configured to permit the consumer and suppliers to correspond with each other to finalize terms of sale and close-out the request list;
(b) wherein the system permits a consumer to request bids from multiple suppliers at one time.

2. A method for conducting a sale transaction between a consumer and a plurality of suppliers, comprising the steps of:
(a) creating a request list containing items that the consumer would like to purchase;
(b) transmitting the request list to the plurality of suppliers for a quote;
(c) receiving the quotes from the plurality of suppliers and selecting suppliers from the plurality of suppliers to contact; and
(d) agreeing to terms of sale and closing the request list.

3. The method according to claim 2, wherein the step of transmitting includes the step of automatically emailing the request list to all suppliers in a pre-defined area.

4. The method according to claim 2, wherein the step of creating a request list further includes the step of pre-selecting the plurality of suppliers that the request list is to be transmitted to.

5. The method according to claim 4, further including the step of automatically transmitting request list to the pre-selected suppliers.

6. The method according to claim 2, wherein the step of transmitting is via email.

7. The method according to claim 2, further including the step of logging into a homepage as a consumer to create the request list.

8. The method according to claim 2, further including the step of logging into a homepage as a supplier to submit quotes on the request list.

9. A method for conducting a sale transaction, comprising the steps of:
(a) providing a centralized hub configured to connect consumers to suppliers, the hub configured for access through a communications network;
(b) having a consumer log into the hub as a consumer and create a request;
(c) using the hub to automatically transmit the request to a plurality of suppliers for quotes on each item included on the request;
(d) having the plurality of suppliers log into the hub as a supplier to submit quotes for each item on the request; and
(e) using the hub to automatically transmit the quotes from the plurality of suppliers to the consumer.

10. The method according to claim 9, wherein the centralized hub includes:
(a) a request module executed by a processor in response to a consumer logging into the hub, the request module being configured to permit the consumer to create a request for submission to a supplier;
(b) a transmission module executed by the processor in response to submission of the request or a quote from the suppliers, the transmission module being configured to automatically transmit the request to suppliers for quote or to transmit the quotes from the suppliers to the consumer;
(c) a bid module executed by the processor in response to the request being transmitted to the suppliers, the bid module being configured to permit the suppliers to quote or bid on items contained in the request; and
(d) a close-out module executed by the processor in response to the quotes being received by the consumer, the close-out module being configured to permit the consumer and suppliers to correspond with each other to finalize terms of sale and close-out the request.

11. The method according to claim 9, wherein the step of creating a request further includes the step of pre-selecting suppliers to send the request to.

12. The method according to claim 11, wherein the request is only transmitted to the plurality of suppliers pre-selected by the consumer.

13. The method according to claim 9, wherein the step of transmitting the request to a plurality of suppliers further includes the step of transmitting the request only to the plurality of suppliers located within a pre-selected area.

14. The method according to claim 9, wherein the step of creating a request further includes the step of using a pre-populated database to select items to be included on the request.

15. The method according to claim 9, further including the step of using the hub to communicate between the consumer and the plurality of suppliers.

16. The method according to claim 9, further including the step of selecting winning quotes from the plurality of suppliers and contacting the winning suppliers to negotiate terms of sale.

17. The method according to claim 16, further including the step of using the hub to pay the winning suppliers.
